(19) United States
(12) Patent Application Publication
(10) Pub. No.: US 2007/0181262 A1
(43) Pub. Date: Aug. 9, 2007

(54) Settling and evaporation tank apparatus, method and system

(76) Inventor: Ricky Dale Patmore, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 11/349,153

(22) Filed: Feb. 8, 2006

(51) Int. Cl. B01D 1/22

(52) U.S. Cl. 159/5

(57) ABSTRACT

An apparatus, method and system for treating contaminated water. The apparatus comprises a tank with a dividing member dividing the tank into a settling region and an evaporation region. The settling region comprises an inlet, weir means, and an outlet, and the evaporation region comprises an inlet and heat application means, the settling region outlet in fluid communication with the evaporation region inlet. The method comprises allowing contaminated water to encounter the weir means, producing contaminants and cleaned water, and transporting the cleaned water to the evaporation region, where the heat application means apply heat to the cleaned water allowing evaporation of the cleaned water. The water treatment system comprises a settling sub-system for receiving contaminated water from a source and allowing contaminants to settle out of the contaminated water, producing cleaned water, and an evaporation sub-system in fluid communication with the settling sub-system for receiving the cleaned water and enabling evaporation of the cleaned water. Preferably, the system further comprises a boiler blowdown sub-system in fluid communication with the evaporation sub-system, wherein an adjacent boiler is allowed to vent boiler contents into the evaporation sub-system during boiler blowdown.

### FIELD OF THE INVENTION

The present invention relates to treatment of contaminated water, and more particularly to water treatment through settling and evaporation.

### BACKGROUND OF THE INVENTION

Many industries generate contaminated water as a by-product of standard processes. For example, the oil and gas industry, both in exploration and production, employs numerous processes that result in substantial quantities of water contaminated by invert mud, dirt, soap or other undesirable substances. Disposal or processing of the contaminated water is a significant problem, and it has spawned a number of attempts to address the situation.

Evaporation tanks have been employed, with some limited success, in treating contaminated water in the oil and gas industry by evaporating the water and leaving a waste residue behind which must be gathered and disposed of. However, the use of steam coils to cause the evaporation often results in undesirable build-up of contaminant on the coils themselves, resulting in cleaning difficulties The large size required for some evaporation tank designs has made their use cost-prohibitive or presented space allocation issues, and a lack of sufficient insulation in the tank walls has rendered some designs undesirable. Safety issues are also readily apparent in some proposed tank designs. Finally, the fact that most of the contaminant remains in the evaporation tank during evaporation means that an air contamination problem can arise when the water level approaches the heating element level.

What is needed, therefore, is a safe and well-insulated water treatment apparatus that provides for efficient removal of contaminants from contaminated water and evaporation of the cleaned water, while also providing ease of cleaning or maintenance and a relatively small footprint.

### SUMMARY OF THE INVENTION

The present invention accordingly seeks to provide a water treatment apparatus, method and system that meet these perceived needs.

According to a first aspect of the present invention there is provided an apparatus for treating contaminated water comprising:
a base member;
a peripheral containment wall connected to the base member, the base member and peripheral containment wall defining a containment volume; and
a dividing member for dividing the containment volume into a settling region and an evaporation region;
the settling region comprising a settling region inlet, weir means, and a settling region outlet; and
the evaporation region comprising an evaporation region inlet and heat application means, the settling region outlet in fluid communication with the evaporation region inlet.

In exemplary embodiments of the apparatus, the peripheral containment wall and the base member each comprise inner and outer walls defining a space therebetween for receiving insulative material. Preferably, the settling region outlet and the evaporation region inlet collectively comprise a cleaned water aperture in the dividing member spaced from the settling region inlet. The weir means preferably comprise an inlet water deflector adjacent the settling region inlet and at least one weir member spaced from the inlet water deflector; the at least one weir member is preferably supported from the peripheral containment wall and the dividing member and preferably comprises at least one water transfer aperture for enabling passage of water from an upstream side of the weir member to a downstream side of the weir member. The heat application means are preferably selected from the group consisting of steam pipes, electric coils, and a combination of steam pipes and electric coils, which steam pipes most preferably receive steam from an adjacent boiler; also, the evaporation region inlet preferably comprises a first inlet for receiving cleaned water from the settling region and a second inlet for receiving boiler contents from the adjacent boiler during boiler blowdown.

According to a second aspect of the present invention there is provided a method for treating contaminated water comprising the steps of:
a. providing a water treatment apparatus comprising a settling region and an evaporation region, the settling region comprising weir means and the evaporation region comprising heat application means;
b. transporting the contaminated water from a contaminated water source to the settling region;
c. allowing the contaminated water to encounter the weir means, producing contaminants and cleaned water;
d. transporting the cleaned water to the evaporation region;
e. using the heat application means to apply heat to the cleaned water; and
f. allowing evaporation of the cleaned water.

In exemplary embodiments of the method, the weir means comprise an inlet water deflector adjacent the settling region inlet and at least one weir member spaced from the inlet water deflector, whereby contaminated water transported to the settling region first encounters the inlet water deflector and then the at least one weir member, causing the contaminants to settle out of the contaminated water before transporting the cleaned water to the evaporation region. Preferably, the heat application means comprise steam pipes, the method then comprising the additional step of allowing steam to enter and heat the steam pipes, and the water treatment apparatus further comprises means for receiving boiler contents into the evaporation region, the method then comprising the additional step of allowing boiler contents to enter the evaporation region during a boiler blowdown. The water treatment apparatus preferably further comprises an evaporation region outlet for releasing unevaporated cleaned water from the evaporation region, the method then comprising the additional step after step d of selectively releasing unevaporated cleaned water from the evaporation region through the evaporation region outlet. The method also preferably comprises the additional step after step c of extracting the contaminants from the settling region.

According to a third aspect of the present invention there is provided a water treatment system comprising:
a settling sub-system for receiving contaminated water from a source and allowing contaminants to settle out of the contaminated water, producing cleaned water; and
an evaporation sub-system in fluid communication with the settling sub-system for receiving the cleaned water and enabling evaporation of the cleaned water.

In exemplary embodiments of the water treatment system, the settling sub-system comprises weir means for enhancing the settling of the contaminants out of the contaminated water, and the evaporation sub-system comprises heat application means for enhancing evaporation of the cleaned water; the water treatment system preferably also comprises insulative means to provide heat retention. The evaporation sub-system preferably comprises outlet means for allowing selective release of the cleaned water before or during evaporation. Preferably, the water treatment system further comprises a boiler blowdown sub-system in fluid communication with the evaporation sub-system, wherein an adjacent boiler is allowed to vent boiler contents into the evaporation sub-system during boiler blowdown.

An apparatus, method and system according to the present invention, then, can provide numerous advantages over the prior art. For example, the settling region provides a “pre-tank” buffer zone for removing contaminants that would otherwise have entered the evaporation region of the tank, thereby addressing issues such as contaminant build-up on the heat application means as well as air contamination concerns. Also, evaporation rates may be improved by reducing the contaminant level in the water before it enters the evaporation region.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 is a top plan view of an apparatus according to the present invention, with the cover removed;

FIG. 2 is a top plan view of the grating cover of the apparatus of FIG. 1;

FIG. 3 is a front elevation view of the apparatus of FIG. 1;

FIG. 4 is a side elevation view of the apparatus of FIG. 1;

FIG. 5 is a rear elevation view of the apparatus of FIG. 1;

FIG. 6 is a simplified top plan view of the apparatus of FIG. 1 showing the inlets and outlets;

FIG. 7 is an elevation view of the first weir member;

FIG. 8 is an elevation view of the second weir member;

FIG. 9 is an elevation view of the third weir member;

FIG. 10 is an elevation view of the dividing member;

FIG. 11 is a cross-sectional view along line A-A of FIG. 1 with the grating cover of FIG. 2 in place;
FIG. 12 is a cross-sectional view along line B-B of FIG. 1 with the grating cover of FIG. 2 in place;

FIG. 13 is a detailed cross-sectional view of the hatch grating;

FIG. 14 is a detailed cross-sectional view of the walk grating support;

FIG. 15 is a detailed plan view of the weir member connection means;

FIG. 16 is a detailed elevation view of an electric coil support bracket;

FIG. 17 is a flowchart illustrating an exemplary method according to the present invention; and

FIG. 18 is a schematic drawing illustrating an exemplary system according to the present invention.

### DETAILED DESCRIPTION OF A PREFERRED EMBODIMENT

Referring now in detail to the accompanying drawings, there is illustrated an exemplary embodiment of an apparatus, method and system according to the present invention, the apparatus generally referred to by the numeral 10

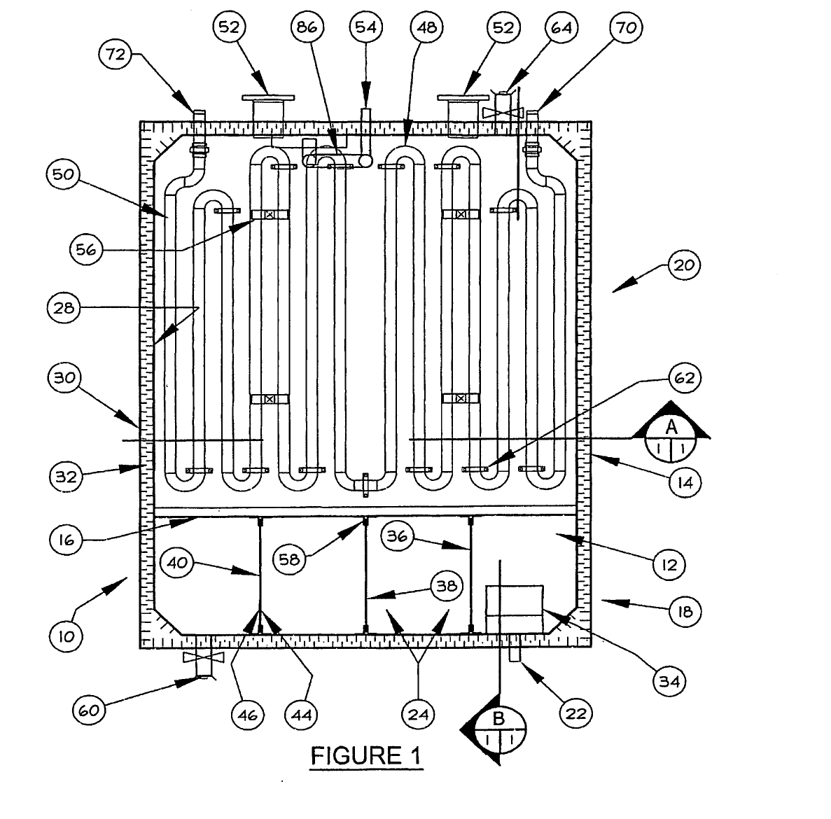

Referring now to FIG. 1, the water treatment apparatus 10 comprises a base member 12 and a peripheral containment wall 14, each preferably made of plate steel, which collectively contain and help define two distinct regions with distinct functionality with respect to contaminated water treatment, namely a settling region 18 and an evaporation region 20. The plate steel forming the peripheral containment wall 14 is most preferably bent and sheared to enhance structural strength, a feature not known in evaporation tanks currently on the market, and the outer wall 30 is preferably painted a dark color with metallic fragments incorporated to help absorb solar energy. The settling. region 18 and evaporation region 20 are separated by a dividing member 16 which is also preferably made of plate steel. The peripheral containment wall 14 and base member 12 each comprise inner and outer walls 28, 30 which are spaced to allow for the presence of insulative material 32 (which is preferably a polyurethane insulation; not shown for the base member 12). The presence of insulative material 32 in the base member 12 is not found in other commercially available evaporation apparatus. The corners of the apparatus 10 are angled in the exemplary embodiment, allowing more insulative material 32 and thereby enhancing the insulative functionality.

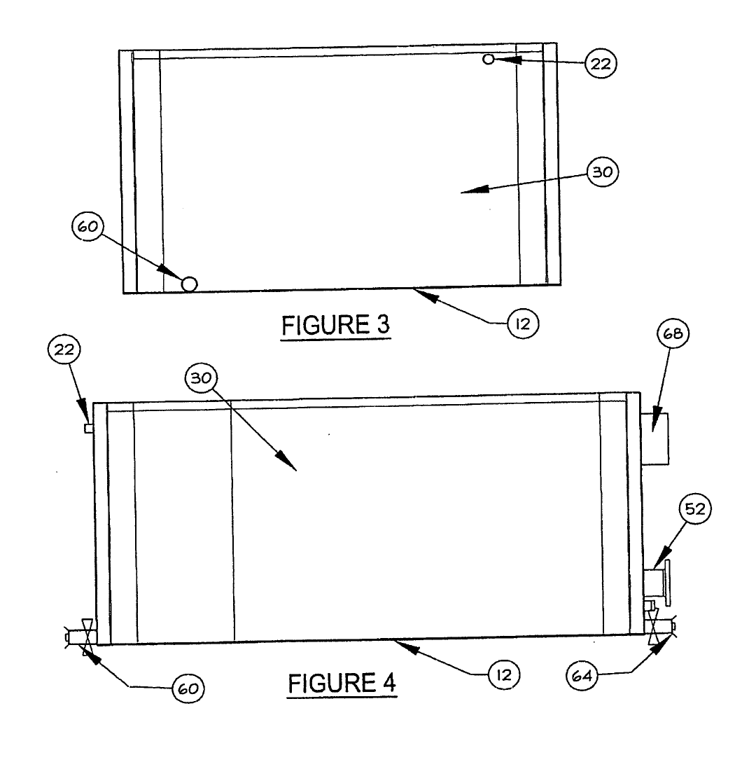

The settling region 18 comprises a settling region inlet 22, in the illustrated embodiment a 2-inch diameter pipe, which enables introduction of contaminated water (not shown) against an inlet water deflector 34. This novel inlet water deflector 34 directs the water downwardly to assist in causing contaminants (not shown) to settle out of the introduced contaminated water, prior to the water being processed by the weir members. As can be seen in FIGS. 1 and 3, the settling region 18 further comprises a 3-inch drainage outlet 60 with a ball valve control and cam-lock.

The weir means 24 within the settling region 18 comprise the inlet water deflector 34 and a series of weir members 36, 38, 40. The water (not shown) is intended to pass over (or through, where there is a water transfer aperture 42, as described below) each of these weir members 36, 38, 40 in series, again causing contaminants to settle out of the water. The cleaned water (not shown) will then exit the settling region 18 by means of a settling region outlet, which in this embodiment is a cleaned water aperture 26 in the dividing member 16 at a location downstream of the last weir member 40; this aperture 26 also functions as the first evaporation region inlet, as described below.

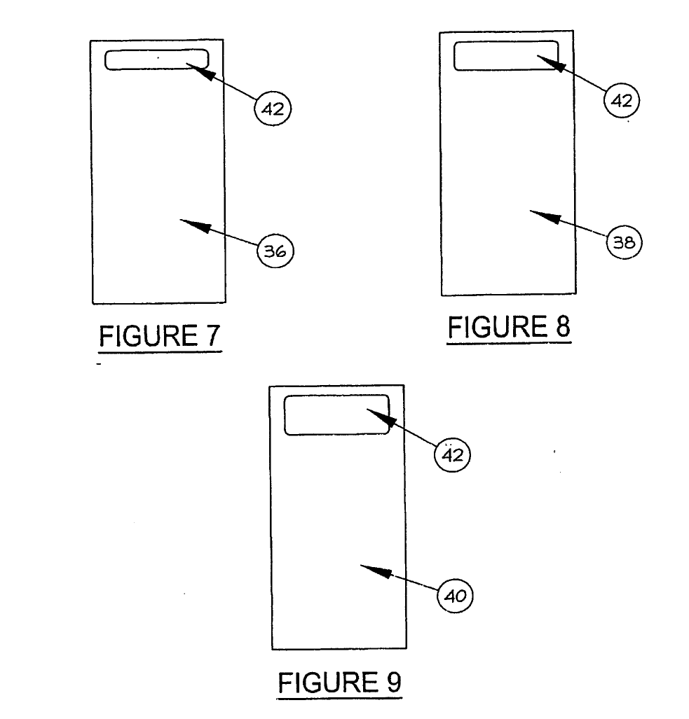

Referring now in detail to FIGS. 7, 8 and 9, the plate steel weir members 36, 38, 40 each comprise a water transfer aperture 42 to enable the passage of water from the upstream side 44 of the weir member to the downstream side 46. In this preferred embodiment, each successive aperture 42 is slightly larger (from 4 to 6 to 8 inches in depth), reflecting the fact that the water should be cleaner after it has passed a previous weir member and more water volume can accordingly be released toward the next weir member. In an alternative embodiment (not shown), each successive weir member can be slightly shorter (and the cleaned water would pass over the top of the weir member), again because the water has lost enough contaminants to allow a greater volume to more easily and quickly proceed toward the next weir member.

Each of the weir members 36, 38, 40 are mounted within the settling region 18 by means of steel angle supports 58, which act as guide rails for positioning of the weir members. Referring in detail to FIGS. 1, 10 and 15, the angle supports 58 are fixedly attached to the dividing member 16, leaving a gap of sufficient size to receive and retain the weir member 36, 38, 40 in a desired position between the settling region inlet 22 and the settling region outlet 26. As the weir members 36, 38, 40 are therefore removable in this exemplary embodiment, easier cleaning of the weir members is enabled.

The weir members 36, 38, 40 can also be provided with a three-way valve (not shown) to open or close off the fluid passage, thereby allowing selective control of the amount of cleaned water that enters the evaporation region 20.

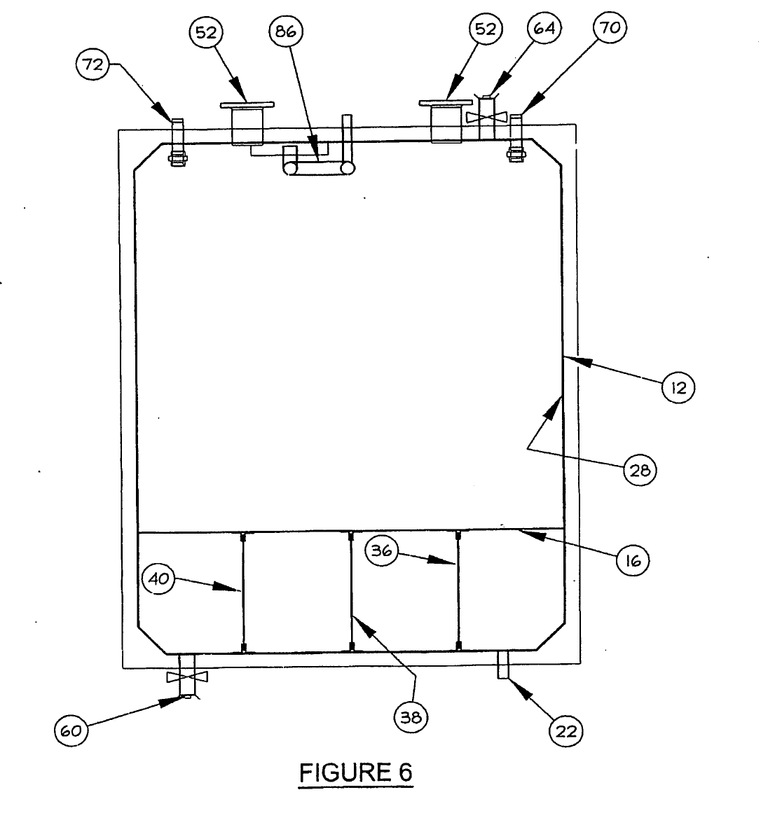

Referring now in detail to FIGS. 1, 4, 5, 6 and 10, the evaporation region 20 comprises a first evaporation region inlet—which, as described above, is the cleaned water aperture 26— and heat application means 48 (which are described in detail below). The evaporation region 20 receives cleaned water from the settling region 18 by means of the cleaned water aperture 26 in the dividing member 16, and the main purpose of the evaporation region 20 is to receive input fluid and subject it to heat to enable evaporation. The evaporation region 20 may also simply be selectively drained by means of the three-inch drainage outlet 64 which is provided with a ball valve control and cam-lock; the apparatus 10 can also be provided with a by-pass system (not shown) to allow cleaned water produced by the settling region 18 to simply be re-routed to the boiler or rig (not shown).

To enable heating of the evaporation region 20 contents, the exemplary embodiment of the apparatus 10 is provided with both steam pipes 50 and electric coils (not shown), with specific reference to FIGS. 1, 4, 5, 6 and 16 The steam pipes 50 are positioned within the evaporation region 20, composed of 2-inch diameter steel loop piping, each section being 70 inches in length to provide more rapid evaporation, and stabilized by Grinnell clamps 62 on a base plate. The steam pipes 50 have both a steam inlet 70 and a steam outlet 72 to enable circulation of the steam (not shown) which heats the pipes 50. The steam is provided by an adjacent boiler (not shown) in this exemplary embodiment, which boiler is part of the boiler blowdown sub-system described below.

As stated above, electric coils are also part of the heat application means 48. The electric coils are employed to heat the evaporation region 20 contents during the months when the boiler would not be active (usually the summer months), as the steam pipes 50 would be employed when the boiler is active and can provide steam to the pipes 50. The electric coils enter the evaporation region 20 by means of 6-inch electric coil flange orifices 52, and they are supported by electric coil support brackets 56 each comprising a cradle 88 and mast 90, which is shown in detail in FIG. 16. As can be seen in FIGS. 4, 5 and 12, the apparatus 10 is also provided with an electrical junction or control box 68 to control electrical input.

The exemplary embodiment of the apparatus 10 is configured to cooperate with an adjacent boiler to provide steam for the steam pipes 50; however, the apparatus 10 is also configured to allow blowdown of the boiler contents (not shown) should such be desired. As can best be seen in FIGS. 1, 6, 11 and 12, there is a second evaporation region inlet 54 which can receive boiler contents from the adjacent boiler. The second inlet 54 is connected to boiler blowdown piping 86 (which expands from a 2-inch initial diameter to a 3-inch diameter once the piping 86 passes through the inner wall 28 into the evaporation region 20, to reduce the force at which the boiler contents strike the inner wall 28, ending in a half pipe deflector), supported by horizontal plate supports 66, which piping 86 directs and deflects the boiler contents to enhance separation of any contaminants from the boiler contents.

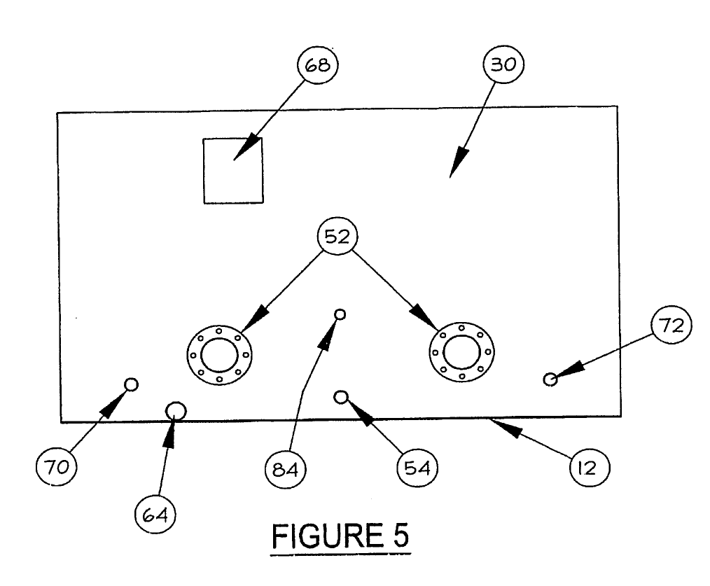

In addition, as seen in FIG. 5, the exemplary embodiment of the apparatus 10 incorporates a water level probe (not shown) which is inserted into the water level probe orifice 84 to help prevent undesired over-evaporation of the evaporation region 20 contents, which might otherwise damage the electrical coil heating system. The water level probe is designed to automatically shut off power to the electrical coils when the water level drops to within 4 inches of the top of the electrical coils.

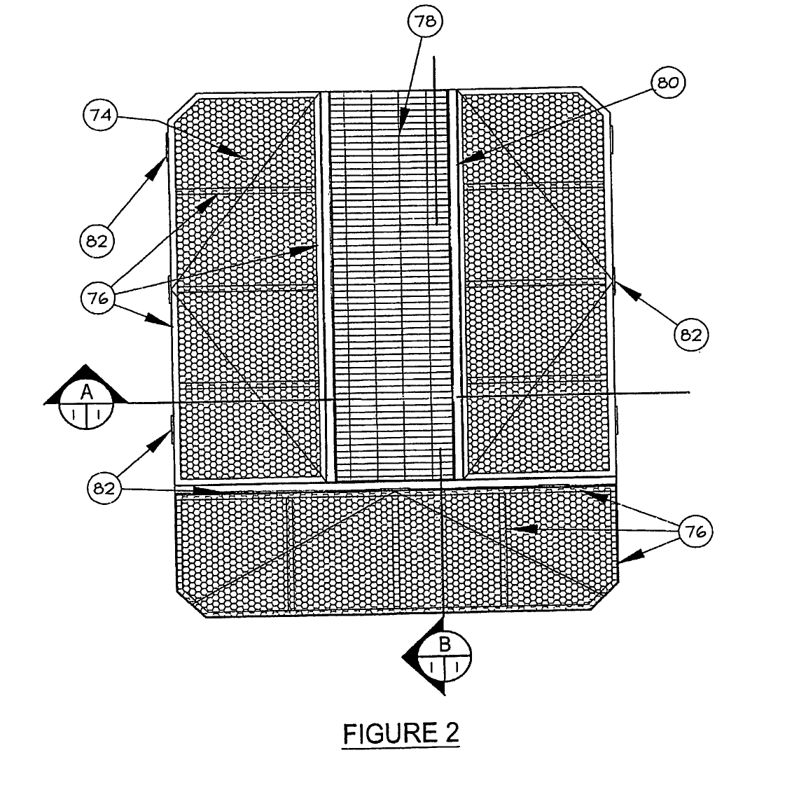

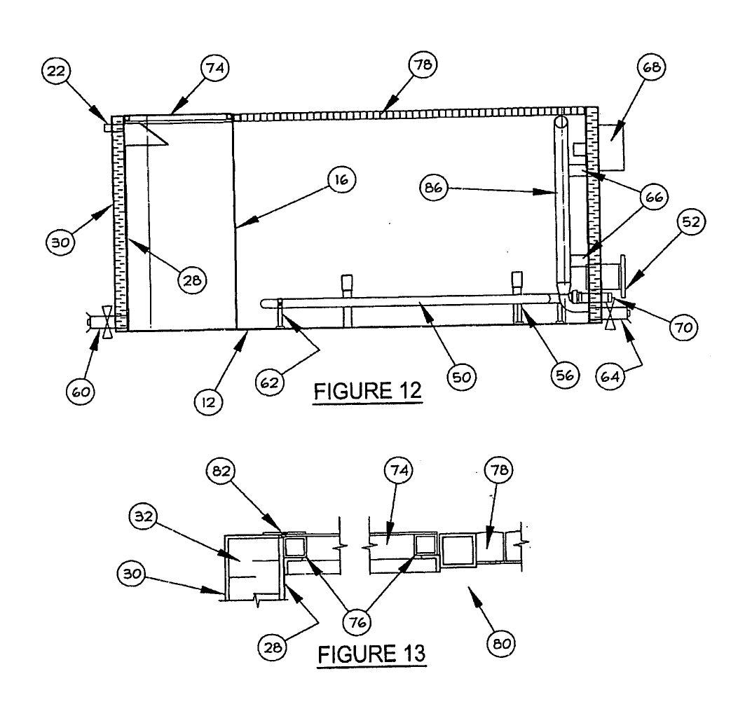

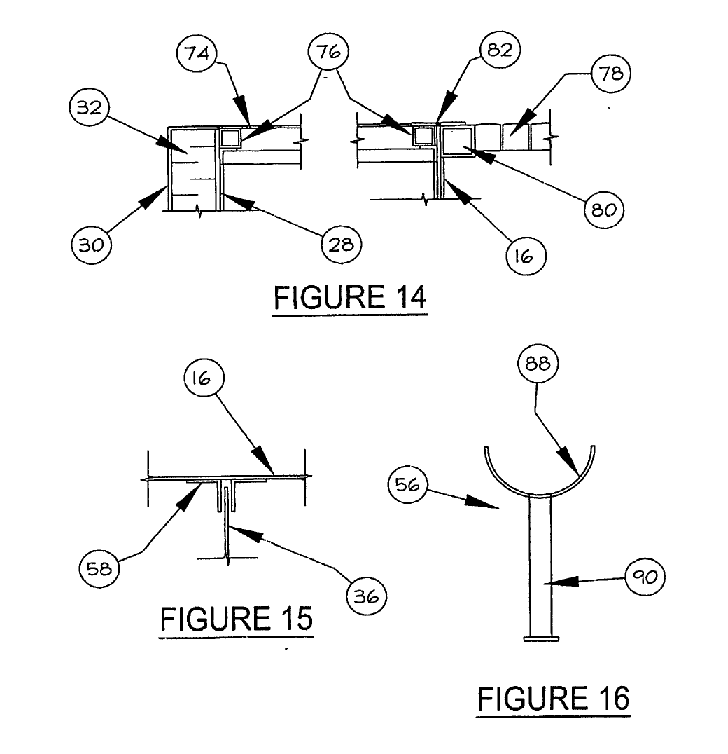

Finally, the exemplary embodiment of the apparatus 10 further comprises a cover for allowing a person to walk across the apparatus 10 and selectively clean it while being protected from the high-temperature contents. Referring now in detail to FIGS. 2, 13 and 14, the cover comprises hatch grating 74 and walkway grating 78, the former composed of 10GA expanded metal and the latter being galvanized steel. The hatch grating 74 is supported on hatch framing 76, and the various segments of the hatch framing 76 are pivotable about 6-inch long hinges 82 to enable access to selected areas of the settling and evaporation regions 18, 20 (to clean those areas, for example). The walkway grating 78 is supported on walkway framing 80, providing a stable surface for persons needing to walk across the surface of the apparatus 10.

The present invention also includes a method for treating contaminated water, and an exemplary embodiment of such a method is illustrated in FIG. 17. To begin, the method at step 100 comprises providing a water treatment tank having: a settling region including an inlet water deflector and at least one weir member; an evaporation region incorporating steam pipes and/or electric coils for heat application and an outlet; and means for receiving boiler contents into the evaporation region A tank according to the exemplary embodiment can weigh approximately 7,000 lbs. empty and would normally be delivered to the desired location by means of a one-ton truck and/or trailer. If the desired application is with a drilling rig, a drilling rig loader (or, if necessary, a 5-ton picker) can be used to lift the tank from the trailer and position it beside the boiler (for winter use) or as otherwise directed by the rig manager (for summer use). If the tank is used with a boiler, a hose would then be used to connect the boiler to the steam inlet on the tank.

In the exemplary method, boiler contents are allowed to enter the evaporation region during boiler blowdown, so a boiler blowdown line would also need to be connected from the boiler to the second evaporation region inlet on the tank. In addition, a line will then be used to connect the contaminated water source to the settling region inlet.

At step 102, steam is allowed to enter and heat the steam pipes, and at step 104 the contaminated water is transported from the contaminated water source to the settling region. If it is undesirable to have the steam pipes heat up prior to water introduction, step 102 can be delayed until after step 108.

When the contaminated water enters the settling region, it will be allowed to first encounter the inlet water deflector at step 106, which directs the contaminated water downwardly, assisting in settling out any contaminants (such as dirt, mud, soap or chemicals). The contaminated water will then encounter each of the weir members in series where a plurality of weir members is employed, and this also helps to generate a separation of contaminants from now-cleaned water. At this point, the contaminants can either be allowed to accumulate in the settling region or they can be extracted at step 106a by using a vacuum truck or other suitable means; where the contaminant is lighter than water (e.g. invert mud) this should be extracted before it can move into the evaporation region.

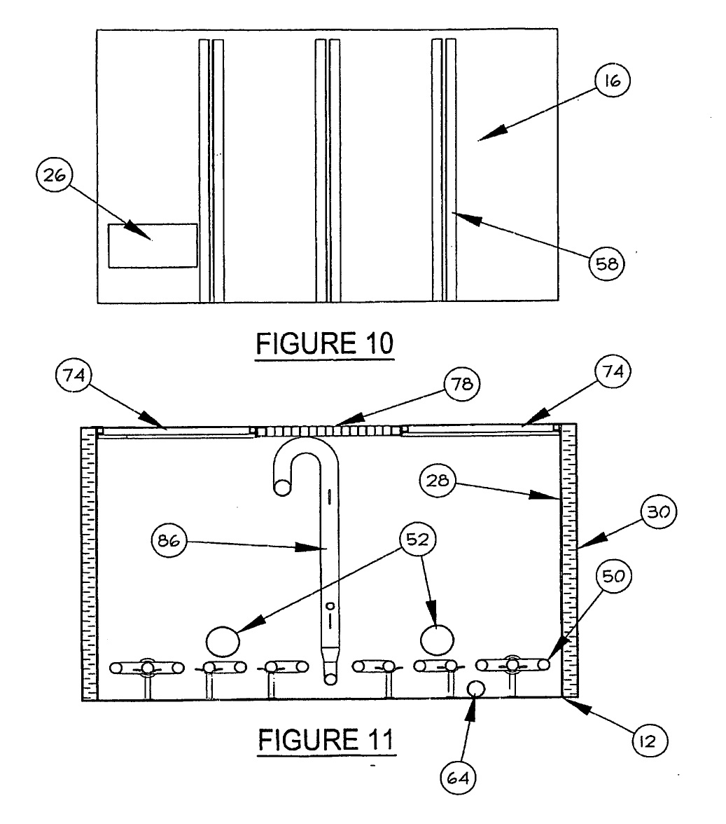

At step 108, the cleaned water is transported into the evaporation region for evaporation or draining. Where the tank has a simple cleaned water aperture in the dividing member, such as illustrated in FIG. 10, this transporting merely entails allowing the cleaned water to flow into the evaporation region. The steam pipes or electric coils have been heated up, or are then heated up, at step 110 and the cleaned water adjacent the heat application means is accordingly heated, as well, allowing evaporation of the cleaned water at step 112. The temperature can be raised to the point where the cleaned water comes to a boil, the rolling of the cleaned water contributing to the evaporation. One additional benefit of this heating is that the adjacent settling region is also subjected to heat, which can assist in the settling process. At step 114, it is possible to selectively release unevaporated cleaned water (if, for example, the volume of incoming fluid is too large for the tank capacity).

In addition, the exemplary method incorporates the treatment of boiler contents during boiler blowdown. At step 108a, boiler contents can be selectively allowed to enter the evaporation region during boiler blowdown. The boiler contents can then be subjected to the heat application means at step 110, resulting in evaporation at step 112 or selective draining at step 114.

The present invention also includes a water treatment system, and an exemplary embodiment of such a system is illustrated in FIG. 18. The illustrated water treatment system is generally referred to by the numeral 200, and it comprises a settling sub-system 202, a boiler blowdown sub-system 206 and an evaporation sub-system 204. The water treatment system 200 also preferably comprises insulative means (not shown) to provide heat retention to enhance the settling and evaporative functionality of the sub-systems.

The settling sub-system 202 is for receiving contaminated water from a contaminated water source 208, allowing contaminants to settle out of the contaminated water, and producing cleaned water. The settling sub-system 202 may also comprise weir means to assist in the settling process, in a manner well known to those skilled in the art.

Once cleaned water has been produced by the settling sub-system 202, the cleaned water is then moved into the evaporation sub-system 204 which enables evaporation of the cleaned water. The evaporation sub-system 204 preferably comprises heat application means for enhancing the evaporative functionality. The cleaned water is then either fully evaporated or, if desired, drained from the evaporation sub-system 204 as unevaporated liquids.

The water treatment system 200 also comprises a boiler blowdown sub-system 206. In addition to the possibility of a boiler providing steam for use in the heat application means of the evaporation sub-system 204, as well as generating heat to potentially enhance the settling functionality of the settling sub-system 202, it may be desirable to vent the boiler contents during boiler blowdown. The boiler contents can be vented directly into the evaporation sub-system 204, which boiler contents can then be either fully evaporated or, if desired, drained from the evaporation sub-system 204 as unevaporated liquids.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. For example, numerous weir means are well known in the art, and a skilled worker could readily apply alternative weir means in an apparatus according to the present invention. The invention is therefore to be considered limited solely by the scope of the appended claims.

1. An apparatus for treating contaminated water comprising:
a base member;
a peripheral containment wall connected to the base member, the base member and peripheral containment wall defining a containment volume; and
a dividing member for dividing the containment volume into a settling region and an evaporation region;
the settling region comprising a settling region inlet, weir means, and a settling region outlet; and
the evaporation region comprising an evaporation region inlet and heat application means, the settling region outlet in fluid communication with the evaporation region inlet.

2. The apparatus of claim 1 wherein the peripheral containment wall and the base member each comprise inner and outer walls defining a space therebetween for receiving insulative material.

3. The apparatus of claim 1 wherein the settling region outlet and the evaporation region inlet collectively comprise a cleaned water aperture in the dividing member spaced from the settling region inlet.

4. The apparatus of claim 1 wherein the weir means comprise an inlet water deflector adjacent the settling region inlet and at least one weir member spaced from the inlet water deflector.

5. The apparatus of claim 4 wherein the at least one weir member is supported from the peripheral containment wall and the dividing member and comprises at least one water transfer aperture for enabling passage of water from an upstream side of the weir member to a downstream side of the weir member.

6. The apparatus of claim 1 wherein the heat application means are selected from the group consisting of steam pipes, electric coils, and a combination of steam pipes and electric coils.

7. The apparatus of claim 6 wherein the steam pipes receive steam from an adjacent boiler.

8. The apparatus of claim 7 wherein the evaporation region inlet comprises a first inlet for receiving cleaned water from the settling region and a second inlet for receiving boiler contents from the adjacent boiler during boiler blowdown.

9. A method for treating contaminated water comprising the steps of:
a. providing a water treatment apparatus comprising a settling region and an evaporation region, the settling region comprising weir means and the evaporation region comprising heat application means;
b. transporting the contaminated water from a contaminated water source to the settling region;
c. allowing the contaminated water to encounter the weir means, producing contaminants and cleaned water;
d. transporting the cleaned water to the evaporation region;
e. using the heat application means to apply heat to the cleaned water; and
f. allowing evaporation of the cleaned water.

10. The method of claim 9 wherein the weir means comprise an inlet water deflector adjacent the settling region inlet and at least one weir member spaced from the inlet water deflector, whereby contaminated water transported to the settling region first encounters the inlet water deflector and then the at least one weir member, causing the contaminants to settle out of the contaminated water before transporting the cleaned water to the evaporation region

11. The method of claim 9 wherein the heat application means comprise steam pipes, the method then comprising the additional step of allowing steam to enter and heat the steam pipes.

12. The method of claim 9 wherein the water treatment apparatus further comprises means for receiving boiler contents into the evaporation region, the method then comprising the additional step of allowing boiler contents to enter the evaporation region during a boiler blowdown.

13. The method of claim 9 wherein the water treatment apparatus further comprises an evaporation region outlet for releasing unevaporated cleaned water from the evaporation region, the method then comprising the additional step after step d of selectively releasing unevaporated cleaned water from the evaporation region through the evaporation region outlet.

14. The method of claim 9 comprising the additional step after step c of extracting the contaminants from the settling region.

15. A water treatment system comprising:
a settling sub-system for receiving contaminated water from a source and allowing contaminants to settle out of the contaminated water, producing cleaned water; and
an evaporation sub-system in fluid communication with the settling sub-system for receiving the cleaned water and enabling evaporation of the cleaned water.

16. The water treatment system of claim 15 wherein the settling sub-system comprises weir means for enhancing the settling of the contaminants out of the contaminated water.

17. The water treatment system of claim 15 further comprising a boiler blowdown sub-system in fluid communication with the evaporation sub-system, wherein an adjacent boiler is allowed to vent boiler contents into the evaporation sub-system during boiler blowdown.

18. The water treatment system of claim 15 wherein the evaporation sub-system comprises heat application means for enhancing evaporation of the cleaned water.

19. The water treatment system of claim 15 wherein the evaporation sub-system comprises outlet means for allowing selective release of the cleaned water before or during evaporation.

20. The water treatment system of claim 15 further comprising insulative means to provide heat retention.
